(19) United States
(12) Patent Application Publication
(10) Pub. No.: US 2026/0359937 A1
(43) Pub. Date: Nov. 12, 2026

(54) METHOD AND APPARATUS FOR CAPTURING MOVING OBJECT

(71) Applicant: NEARTHLAB INC., Seoul (KR)

(72) Inventor: Youngsuk CHUNG, Seoul (KR)

(73) Assignee: NEARTHLAB INC., Seoul (KR)

(21) Appl. No.: 19/712,490

(22) Filed: Jun. 18, 2026

Related U.S. Application Data
(63) Continuation of application No. PCT/KR2024/016068, filed on Oct. 22, 2024.

(30) Foreign Application Priority Data
Mar. 14, 2024 (KR) 10-2024-0035849

(51) Int. Cl. G06T 5/50; B64U 20/80; B64U 101/30; G01S 17/50; G01S 17/933; G06T 7/50; G06T 7/73; G06V 10/764; G06V 20/58; H04N 23/695; H04N 23/90

(52) U.S. Cl. CPC G06T 5/50; B64U 20/80; G01S 17/50; G01S 17/933; G06T 7/50; G06T 7/74; G06V 10/764; G06V 20/58; H04N 23/695; H04N 23/90; B64U 2101/30; G06T 2207/10028; G06T 2207/10032; G06T 2207/20201; G06T 2207/20212; G06T 2207/30184; G06T 2207/30204; G06T 2207/30252

(57) ABSTRACT

A method of capturing a moving object according to an aspect includes: obtaining movement information of at least one element included in an object; generating first images in which at least a portion of the at least one element is captured through at least one camera of an aerial vehicle; and generating a second image corresponding to the at least one element by using the first images and the movement information.

### CROSS REFERENCE TO RELATED APPLICATIONS

This application is a continuation U.S. National Stage Application of International Application No. PCT/KR2024/016068 filed Oct. 22, 2024, which claims priority to KR application 10-2024-0035849 filed Mar. 14, 2024, in the Korean Intellectual Property Office, the entire disclosure of which is incorporated herein by reference for all purposes.

### TECHNICAL FIELD

The present disclosure relates to a method and an apparatus for capturing a moving object.

### BACKGROUND ART

An aerial vehicle flies to approach an object, and various information about the object may be collected through a camera of the aerial vehicle. A capturing technology using the aerial vehicle is applied in combination with various technical fields, and is also utilized for inspecting an industrial structure. When the object is the industrial structure, failure, damage, and the like of the industrial structure may be identified by capturing an exterior or an interior of the object through the camera of the aerial vehicle.

When the aerial vehicle captures the moving object, conventionally, images were conventionally generated by performing capturing after stopping movement of the object. However, if the movement of the object is forcibly stopped, a loss may occur as the object fails to perform its original function. In addition, if capturing is delayed until the movement of the object stops, resources unnecessary for capturing the object may be wasted.

### DISCLOSURE

### Technical Problem

Provided are a method and an apparatus for capturing a moving object. Also provided is a computer-readable recording medium recording a program for executing the method on a computer. The technical problems to be solved are not limited to the technical problems as described above, and other technical problems may exist.

### Solution to Problem

A method of capturing a moving object according to an aspect includes: obtaining movement information of at least one element included in an object; generating first images in which at least a portion of the at least one element is captured through at least one camera of an aerial vehicle; and generating a second image corresponding to the at least one element by using the first images and the movement information.

A computer-readable recording medium according to another aspect includes a recording medium recording a program for executing the above-described method on a computer.

An apparatus for capturing a moving object according to another aspect includes: at least one memory; and at least one processor, wherein the at least one processor is configured to obtain movement information of at least one element included in an object, generate first images in which at least a portion of the at least one element is captured through at least one camera of an aerial vehicle, and generate a second image corresponding to the at least one element by using the first images and the movement information.

An aerial vehicle according to another aspect includes: at least one camera; at least one memory; and at least one processor, wherein the at least one processor is configured to obtain movement information of at least one element included in an object, generate first images in which at least a portion of the at least one element is captured through the at least one camera, and generate a second image corresponding to the at least one element by using the first images and the movement information.

### DESCRIPTION OF DRAWINGS

FIG. 1 is a diagram for describing an example of capturing an object by using an aerial vehicle according to an embodiment.

FIG. 2 is a diagram for describing a relationship among an aerial vehicle, a controller, a server, and a station according to an embodiment.

FIG. 3 is a configuration diagram for describing an example of an aerial vehicle according to an embodiment.

FIG. 4 is a flowchart for describing an example of a method of capturing a moving object according to an embodiment.

FIG. 5 is a diagram for describing examples in which a processor obtains movement information of an element according to an embodiment.

FIG. 6 is a diagram for describing an example in which a processor sets a movement path of an aerial vehicle according to an embodiment.

FIG. 7 is a diagram for describing an example in which a processor captures while moving an aerial vehicle up and down according to an embodiment.

FIG. 8 is a diagram for describing an example in which a processor determines a distance between an aerial vehicle and an object according to an embodiment.

FIG. 9 is a diagram for describing an example in which an aerial vehicle performs capturing at the same position according to an embodiment.

FIG. 10 is a diagram for describing an example in which a processor generates a second image according to an embodiment.

FIG. 11 is a diagram for describing an example in which a processor generates first images when a camera is a TDI camera according to an embodiment.

FIG. 12 is a configuration diagram for describing an example of an apparatus for capturing a moving object according to an embodiment.

FIG. 13 is a flowchart for describing a method of capturing a wind power generator according to an embodiment.

### DETAILED DESCRIPTION OF THE INVENTION

Terms used in the embodiments have been selected, as much as possible, from general terms currently widely used, but these may change according to the intention of a person skilled in the art, precedents, the emergence of new technology, and the like. Also, in certain cases, there are terms arbitrarily selected by the applicant, and in this case, their meanings will be described in detail in the corresponding description part. Therefore, the terms used in the specification should be defined based on the meanings the terms have and the overall contents throughout the specification, rather than the simple names of the terms.

When a part “includes” or “comprises” an element throughout the specification, it means that other elements may be further included rather than excluding other elements unless specifically stated to the contrary.

In addition, terms including ordinal numbers such as “first” or “second” used in the specification may be used to describe various elements, but the elements should not be limited by the terms. The terms may be used for the purpose of distinguishing one element from another element.

Hereinafter, embodiments will be described in detail with reference to the accompanying drawings. However, the embodiments may be implemented in various different forms and are not limited to the examples described herein.

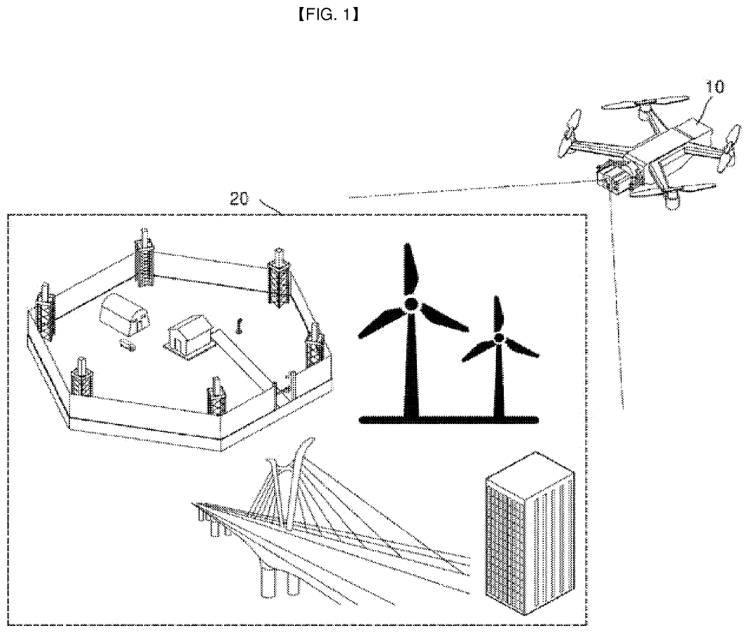

FIG. 1 is a diagram for describing an example of capturing an object by using an aerial vehicle according to an embodiment.

The aerial vehicle 10 may correspond to any flyable aircraft including a drone, an Unmanned Aerial Vehicle (UAV), an Unmanned Aerial Mobility (UAM), an aircraft, a helicopter, and the like.

The aerial vehicle 10 may fly alone or together with a plurality of aerial vehicles capable of collaboration. Also, the aerial vehicle 10 may collaborate with other types of apparatuses. In addition, the aerial vehicle 10 may automatically fly around the object 20 along a predetermined movement path, and may manually fly around the object 20 according to the control of a user.

The aerial vehicle 10 may capture the object 20 while flying around the object 20. For example, an image in which the object 20 is captured may be used to determine whether there is a defect (e.g., failure, damage, etc.) in the object 20. The user may detect, recognize, and/or identify the object 20 through the aerial vehicle 10.

As an example, the aerial vehicle 10 may capture a body or blades of a wind power generator. Specifically, the aerial vehicle 10 may capture the body or the blades while flying around the wind power generator. For example, the aerial vehicle 10 may take off from a station at a starting point and fly to a nose of the wind power generator. Also, the aerial vehicle 10 may start capturing from the nose of the wind power generator, and may capture the blades while autonomously flying (or manually flying) along the blades. In general, the wind power generator may include three blades, and the aerial vehicle 10 may obtain images by capturing the three blades. At this time, the images captured by the aerial vehicle 10 may be utilized for an inspection of the blades.

As another example, the aerial vehicle 10 may capture a surface of a large building. For example, the aerial vehicle 10 may obtain images by capturing the surface while flying around the large building. At this time, the images captured by the aerial vehicle 10 may be utilized for an inspection of the surface of the large building.

As another example, the aerial vehicle 10 may capture various structures included in a military facility. For example, the military facility may include an iron fence, a building, an exterior wall, and the like, and the aerial vehicle 10 may capture surfaces of the structures while flying over various points of the military facility. At this time, the images captured by the aerial vehicle 10 may be utilized for an inspection of the military facility.

In FIG. 1, a wind power generator, a bridge, a large building, and a military facility are illustrated as the object 20, but the present disclosure is not limited thereto. In other words, the object 20 may be applicable without limitation as long as it is a structure having a shape. As an example, the object 20 may be a structure in an industrial field. The object 20 may be a structure for power generation (e.g., a wind power generator, a thermal power plant, a hydroelectric power plant, a nuclear power plant, a solar power generator, etc.), a large building (e.g., a factory, an exhibition hall, a stadium, etc.), a bridge, a dam, a power distribution line, a road, and the like, but is not limited thereto. As another example, the object 20 may be a structure (e.g., an iron fence, an ammunition depot, an exterior wall, etc.) that needs to be detected or from which information needs to be collected in security and military fields. As another example, anything that is difficult or dangerous for a user to visually check in its entirety and requires a lot of manpower and cost for inspection may correspond to the object 20.

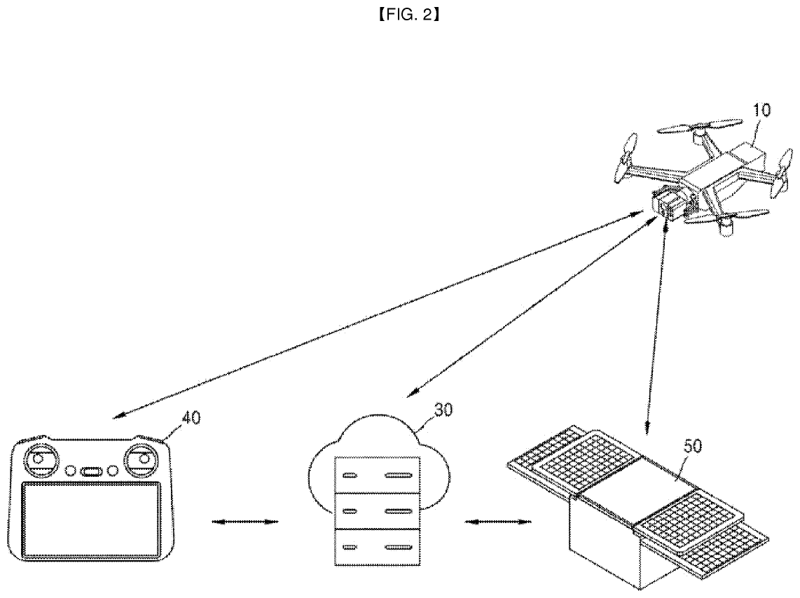

FIG. 2 is a diagram for describing a relationship among an aerial vehicle, a controller, a server, and a station according to an embodiment.

Referring to FIG. 2, the server 30, the controller 40, and the station 50 may control the aerial vehicle 10 independently or in combination. For example, the server 30, the controller 40, and the station 50 may control a flight (e.g., movement, rotation, etc.) of the aerial vehicle 10 or control capturing of the aerial vehicle 10.

The aerial vehicle 10 includes at least one camera, and may capture the object 20 by using the camera. For example, the camera may be provided at a position advantageous for capturing during the flight of the aerial vehicle 10 (e.g., an area in front of or at a lower front portion of the aerial vehicle that is not obscured by a propeller, etc.).

For example, the aerial vehicle 10 may fly by using a Global Navigation Satellite System (GNSS) and/or an Inertial Navigation System (INS).

For example, the aerial vehicle 10 may transmit and receive data to and from the server 30, the controller 40, and/or the station 50. In addition, the controller 40 and the server 30, the server 30 and the station 50, and the station 50 and the controller 40 may transmit and receive data to and from each other.

Here, the data may include data necessary for controlling the flight of the aerial vehicle 10, data regarding a flight image of the aerial vehicle 10, data regarding an image in which the aerial vehicle 10 captures the object 20, and the like.

The flight image represents a field of view of the aerial vehicle 10 when the aerial vehicle 10 flies. For example, the flight image may be a dynamic image obtained in real time, but is not limited thereto.

The image in which the aerial vehicle 10 captures the object 20 means an image captured while the aerial vehicle 10 flies around the object 20. At this time, the image in which the aerial vehicle 10 captures the object 20 may be utilized as an image for identifying whether there is a defect in the object 20. In this case, the image in which the aerial vehicle 10 captures the object 20 may be referred to as an inspection image.

For example, the flight image may be an image having a relatively lower resolution (or lower Ground Sampling Distance (GSD)) than the inspection image, and the inspection image may be an image having a relatively higher resolution (or higher GSD) than the flight image. Meanwhile, depending on the type of the aerial vehicle 10, a camera generating the flight image and a camera generating the inspection image may be the same or different.

A user may control the aerial vehicle 10 by using an interface of the controller 40. For example, the controller 40 may generate a control signal according to a user input received through the interface, and transmit the control signal to the aerial vehicle 10. The controller 40 may transmit the control signal to the aerial vehicle 10 in a wireless communication manner. The control signal may be a signal for controlling the flight, posture, navigation, etc. of the aerial vehicle.

The aerial vehicle 10 may rotate a propeller by controlling a motor according to the control signal received from the controller 40. The aerial vehicle 10 may perform movement, rotation, etc. by changing a speed and/or posture, etc. due to the rotation of the propeller. Here, the posture of the aerial vehicle may be represented by pitch (Y), roll (X), yaw (Z), and the like. In addition, the aerial vehicle may perform capturing of the object 20, etc. according to the control signal received from the controller 40.

The controller 40 may further include a display device, and the user may check the flight image and/or the inspection image of the aerial vehicle 10 through the display device.

The controller 40 may be a device installed with an application for controlling the aerial vehicle 10. For example, the device installed with the application may be various portable devices such as a smartphone, a tablet, a smart pad, a laptop, a wearable device, and the like.

The server 30 or the station 50 may directly transmit a control signal to the aerial vehicle 10 to control the aerial vehicle. In addition, the aerial vehicle 10 may transmit the flight image and/or the inspection image to the server 30, the controller 40, or the station 50.

Each of the aerial vehicle 10, the server 30, the controller 40, and the station 50 may analyze the inspection image. For example, the analysis of the inspection image may be checking whether there is a defect of the object 20 on the inspection image through an algorithm such as machine learning, deep learning, and the like. The aerial vehicle 10 may directly determine whether there is a defect in the object 20, or may transmit the inspection image to the server 30, the controller 40, or the station 50. The server 30, the controller 40, or the station 50 may analyze the inspection image received from the aerial vehicle 10 to determine whether there is a defect in the object 20.

Meanwhile, when the object 20 is moving, a quality of the image in which the aerial vehicle 10 captures the object 20 may be degraded. Here, that the object 20 is moving includes not only the object 20 moving while changing its position but also an element moving while the object 20 is in a fixed state. For example, when the object 20 is a wind power generator, the movement of the object 20 may also include rotation of a blade.

When the object 20 is a wind power generator, conventionally, the wind power generator was captured (an inspection image is generated) in a state where the blades are stopped. When the blades are stopped, the generation of power stops, so that the power generation efficiency of the wind power generator is reduced.

In addition, to stop the blades, a worker needs to move to a place where the wind turbine is located, which causes unnecessary time and cost to capture the wind power generator. Also, since it is necessary to wait for the blades to move to a position suitable for capturing depending on the surrounding wind, unnecessary time and cost occur in capturing the wind power generator.

If the wind power generator is captured in a state where the blades are rotating, the rotation speed of the blade increases toward a tip portion of the blade, and thus the quality of the inspection image is degraded.

The aerial vehicle 10 according to an embodiment may generate a high-resolution image even in a state where the object 20 is moving. For example, when the object 20 is a wind power generator, the aerial vehicle 10 may generate an image of the blade with high resolution (less blur) even while the blade is rotating.

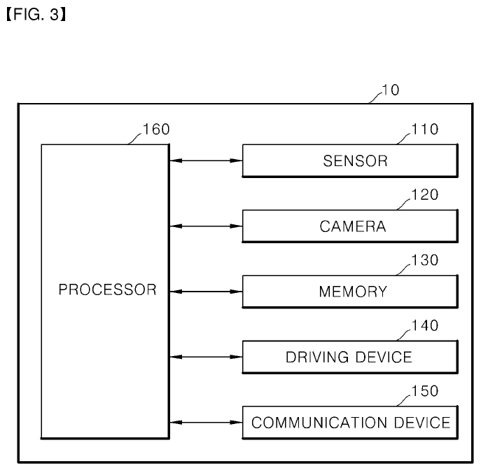

FIG. 3 is a configuration diagram for describing an example of an aerial vehicle according to an embodiment.

Referring to FIG. 3, the aerial vehicle 10 may include a sensor 110, a camera 120, a memory 130, a driving device 140, a communication device 150, and a processor 160. However, the components of the aerial vehicle 10 are not limited to those illustrated in FIG. 3. In other words, the aerial vehicle 10 may further include at least one component in addition to the components illustrated in FIG. 3, or at least one of the components illustrated in FIG. 3 may be omitted.

The sensor 110 detects various information necessary for operations (e.g., flight, capturing, etc.) of the aerial vehicle 10, such as the aerial vehicle 10 itself, a surrounding environment of the aerial vehicle 10, identification of the object 20, checking a distance between the aerial vehicle 10 and the object 20, and the like. The sensor 110 may include a gyro sensor, a barometer, an ultrasonic sensor, a magnetic sensor, an acceleration sensor, a proximity sensor, a LiDAR, a radar, and/or a GPS sensor, but is not limited thereto.

For example, the gyro sensor and/or the acceleration sensor may measure a 3-axis angular velocity of the aerial vehicle 10. The barometer may measure an atmospheric pressure change and/or an atmospheric pressure around the aerial vehicle 10. Since the atmospheric pressure varies depending on an altitude, the aerial vehicle 10 may measure the altitude of the aerial vehicle 10 by using the barometer. The ultrasonic sensor may measure a distance between the aerial vehicle 10 and the ground or the object 20. The magnetic sensor is a kind of terrestrial magnetism sensor or compass sensor, and may detect geomagnetic information.

For example, the proximity sensor may measure a proximity state of the object 20 with respect to the aerial vehicle 10 and a distance between the aerial vehicle 10 and the object 20, and may include an ultrasonic sensor capable of outputting ultrasonic waves and measuring the distance to the object 20 from a signal reflected from the object 20. The GPS sensor may calculate current coordinates (x, y, z) of the aerial vehicle 10 by using a GPS signal.

The sensor 110 may include an attitude and heading reference system (AHRS). For example, the attitude and heading reference system may include an inertial sensor or an inertial measurement unit (IMU). For example, the attitude and heading reference system includes a gyro sensor, an acceleration sensor, and a magnetic sensor, and may output attitude values (φ, θ, ψ) of the aerial vehicle 10 by fusing sensor values. Here, the attitude values (φ, θ, ψ) may be angles based on three-dimensional coordinates (x-axis coordinates, y-axis coordinates, and z-axis coordinates) according to GPS coordinates.

The camera 120 may capture the object 20 according to an instruction of the processor 160. For example, the aerial vehicle 10 may include at least one camera, and may include a low-resolution camera and/or a high-resolution camera.

The camera 120 may be coupled with a gimbal capable of adjusting an angle. Accordingly, a capturing angle of the camera 120 may be adjusted by the gimbal.

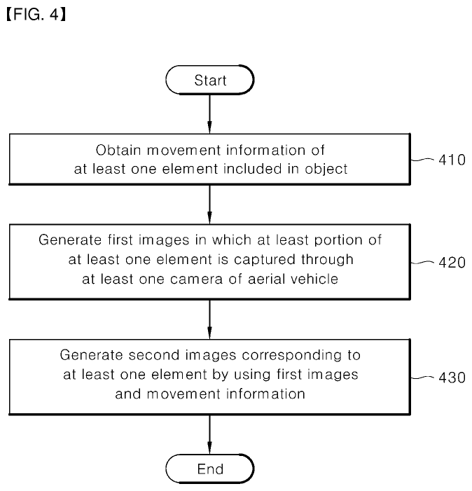

The memory 130 may include a non-transitory arbitrary computer-readable recording medium. As an example, the memory 130 may include a permanent mass storage device such as a random access memory (RAM), a read only memory (ROM), a disk drive, a solid state drive (SSD), a flash memory, and the like. As another example, a permanent mass storage device such as a ROM, an SSD, a flash memory, a disk drive, etc. may be a separate permanent storage device distinguished from the memory. In addition, an operating system (OS) and at least one program code (e.g., a code for the processor 160 to perform an operation to be described later with reference to FIGS. 4 to 13) may be stored in the memory 130.

These software components may be loaded from a computer-readable recording medium separate from the memory 130. The separate computer-readable recording medium may be a recording medium directly connectable to a computer, and may include, for example, a computer-readable recording medium such as a floppy drive, a disk, a tape, a DVD/CD-ROM drive, a memory card, and the like. Alternatively, the software components may be loaded into the memory 130 through the communication device 150 rather than the computer-readable recording medium. For example, at least one program may be loaded into the memory 130 based on a computer program (e.g., a computer program for the processor 160 to perform an operation to be described later with reference to FIGS. 3 to 13) installed by files provided by developers or a file distribution system distributing installation files of an application through the communication device 150.

The driving device 140 controls driving of a motor at a speed and in a direction according to an instruction of the processor 160, and accordingly, a rotation speed and direction of a propeller connected to the motor may be controlled. For example, the driving device 140 may include the motor and the propeller.

The communication device 150 performs data communication between the aerial vehicle 10 and an external device. For example, the communication device 150 may communicate with the controller 40, the server 30, and/or the station 50 through various communication methods such as infrared communication, Radio Frequency (RF) communication, Wi-Fi communication, ZigBee communication, Bluetooth communication, laser communication, Ultra-Wideband (UWB) communication, LTE, 5G, 6G, Wireless LAN, and the like. However, the communication method employed in the communication device 150 is not limited to those described above.

The processor 160 may process instructions of a computer program by performing basic arithmetic, logic, and input/output operations. Here, the instructions may be provided from the memory 130 or an external device (e.g., the server 30, the controller 40, the station 50, etc.). In addition, the processor 160 may overall control operations of other components included in the aerial vehicle 10.

For example, functions performed by respective modules included in the processor 160 may be performed by one processor or may be performed by respective separate processors. The processor 160 may execute an operation or data processing related to control and/or communication of at least one other component of the aerial vehicle 10.

The processor 160 obtains movement information of at least one element included in the object 20.

As an example, the processor 160 may identify an initial position of the element at a reference time point before capturing is performed. Also, the processor 160 may sense a movement of the element through a LiDAR sensor of the aerial vehicle 10. Also, the processor 160 may obtain the movement information by using the initial position and the sensed movement of the element.

As another example, the processor 160 may identify an initial position of the element at a reference time point before capturing is performed. Also, the processor 160 may obtain the movement information by using the initial position of the element and a preset speed (a speed set for the element to move).

The processor 160 generates first images in which at least a portion of the at least one element is captured through at least one camera 120.

For example, the processor 160 may set a movement path of the aerial vehicle 10 in consideration of an estimated cost according to the capturing. Also, the processor 160 may generate the first images as the element is captured at each of a plurality of capturing positions set according to the movement path. The processor 160 may set a plurality of capturing positions in each of capturing directions, and may generate the first images by capturing elements at each of the capturing positions.

For example, the movement path may be set such that a plurality of capturing positions are set on one side surface of the object 20, and after capturing at the capturing positions is completed, the aerial vehicle 10 moves to another side surface of the object 20.

In addition, a distance between the aerial vehicle 10 and the object 20 may be determined based on a focal length of a lens included in the camera 120, a length in a first direction of an image sensor included in the camera 120, and a length in the first direction of an area captured through the camera 120. As an example, when the aerial vehicle 10 includes a single camera, the processor 160 may control the single camera to capture while adjusting a capturing angle at each of capturing positions. As another example, when the aerial vehicle 10 includes a plurality of cameras, the processor 160 may control the plurality of cameras to simultaneously capture at each of capturing positions. The capturing position of the aerial vehicle 10 may be indicated by GPS coordinates of the aerial vehicle 10, and may be a position where the aerial vehicle 10 hovers when capturing the object 20. The capturing position may be determined according to the distance between the aerial vehicle 10 and the object 20 and the capturing direction.

The processor 160 generates a second image corresponding to the at least one element by using the first images and the movement information.

For example, the processor 160 may classify the first images for each element by using the movement information. Also, the processor 160 may generate the second image by combining the images classified for each element. The processor 160 generates the second image by combining the first images obtained by capturing any one element in any one capturing direction.

A detailed description of the operations of the aerial vehicle 10 described above with reference to FIG. 3 will be described later with reference to FIGS. 4 to 13.

For example, the processor 160 may be implemented as an array of a plurality of logic gates, or may be implemented as a combination of a general-purpose microprocessor and a memory in which a program executable in the microprocessor is stored. For example, the processor 160 may include a general-purpose processor, a central processing unit (CPU), a graphics processing unit (GPU), a neural processing unit (NPU), a microprocessor, a digital signal processor (DSP), a controller, a microcontroller, a state machine, and the like. In some environments, the processor 160 may include an application specific integrated circuit (ASIC), a programmable logic device (PLD), a field programmable gate array (FPGA), and the like. For example, the processor 160 may refer to a combination of processing devices, such as a combination of a digital signal processor (DSP) and a microprocessor, a combination of a plurality of microprocessors, a combination of one or more microprocessors combined with a digital signal processor (DSP) core, or a combination of any other such configurations.

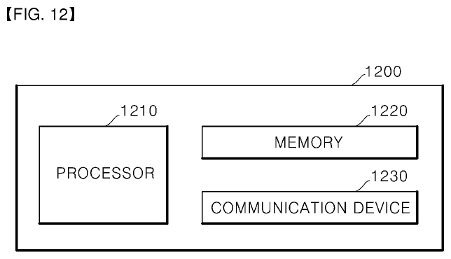

Meanwhile, the operation of the processor 160 described above with reference to FIG. 3 may be implemented by a separate apparatus. At this time, the separate apparatus (hereinafter, referred to as an “apparatus for capturing a moving object”) may be included in at least one of the aerial vehicle 10, the server 30, the controller 40, the station 50, and other external devices. When the apparatus for capturing a moving object is included in at least one of the server 30, the controller 40, the station 50, and other external devices, the aerial vehicle 10 may capture a static image and a dynamic image, and transmit the captured images to the apparatus for capturing a moving object. An example of the apparatus for capturing a moving object will be described later with reference to FIG. 12.

FIG. 4 is a flowchart for describing an example of a method of capturing a moving object according to an embodiment.

The method illustrated in FIG. 4 consists of steps processed in a time-series manner in the aerial vehicle 10 or the processor 160 illustrated in FIGS. 1 to 3. Therefore, even if omitted below, the descriptions given above regarding the aerial vehicle 10 or the processor 160 may also be applied to the method illustrated in FIG. 4. In addition, the operations of the processor 160 below may be performed by the apparatus for capturing a moving object illustrated in FIG. 12.

In step 410, the processor 160 obtains movement information of at least one element included in the object 20.

Here, the element refers to a component of the object 20. For example, when the object 20 is a wind power generator, the element may be a blade, a turbine, a generator, or the like. The object 20 may correspond without limitation as long as it is a movable structure, and the element may correspond without limitation as long as it is a component of the object 20. Hereinafter, for convenience of description, it will be described that the object 20 is a wind power generator and the element is a blade, but the present disclosure is not limited thereto.

As described above with reference to FIG. 2, that the object 20 is moving includes not only the object 20 moving while changing its position but also the element moving while the object 20 is in a fixed state. Therefore, when the object 20 is a wind power generator, that the object 20 is moving includes that the blades are rotating.

Here, the movement information refers to various information regarding the movement of the object 20 or the element. For example, when the object 20 is a wind power generator, the movement information may include a position where the blade has moved during capturing (e.g., an initial position and a final position), the number of rotations of the blade, a rotation speed of the blade, a time required for the blade to make one rotation, and the like.

Specifically, examples in which the processor 160 obtains the movement information of the element are as follows.

As an example, the processor 160 may identify an initial position of the element at a reference time point before capturing is performed. Also, the processor 160 may sense a movement of the element through the LiDAR sensor of the aerial vehicle 10. Also, the processor 160 may obtain the movement information of the element by using the initial position and the sensed movement of the element.

As another example, the processor 160 may identify an initial position of the element at a reference time point before capturing is performed. Also, the processor 160 may obtain the movement information of the element by using the initial position of the element and a preset speed (a speed preset for the element to move). The processor 160 may identify which element is the captured element by using the movement information. When capturing a wind power generator, the processor 160 may identify which blade is the captured blade by using movement information of the blades.

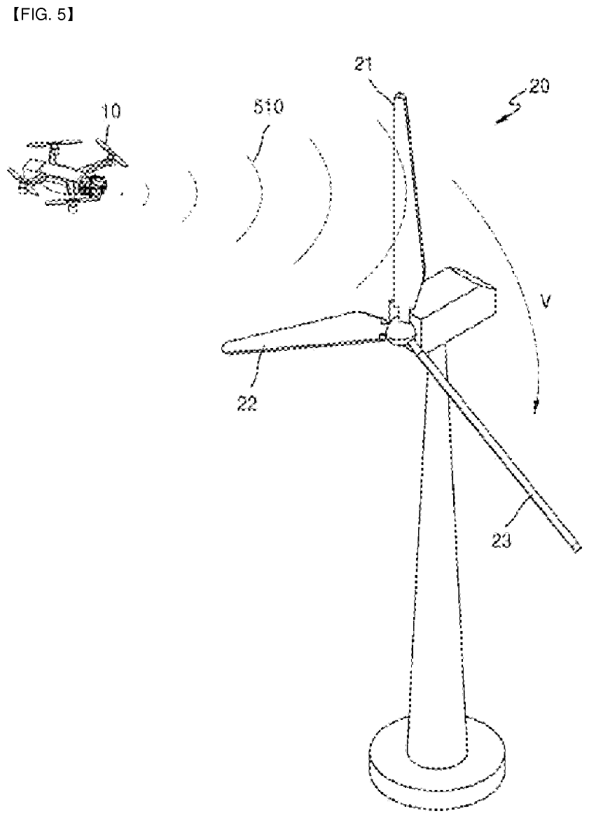

While the blades are rotating, the aerial vehicle 10 captures the wind power generator including the blades multiple times. Therefore, in order to identify which blade is included in the image among the plurality of blades included in the wind power generator, the movement information of the blade needs to be checked. Hereinafter, examples in which the processor 160 obtains the movement information of the element will be described with reference to FIG. 5.

FIG. 5 is a diagram for describing examples in which a processor obtains movement information of an element according to an embodiment.

Referring to FIG. 5, the object 20 includes a total of three elements 21, 22, 23. At this time, it is assumed that the elements 21, 22, 23 are rotating.

First, the processor 160 identifies initial positions of the elements 21, 22, 23 at a reference time point before capturing is performed. For example, when there are distinguishable markings on the respective elements 21, 22, 23, the processor 160 may identify the initial positions of the elements 21, 22, 23 by recognizing the markings through the camera 120.

Alternatively, when a marking is present on only any one 21 of the elements 21, 22, 23, the processor 160 may check positional relationships between the element 21 on which the marking is present and the other elements 22, 23 through the camera 120. Accordingly, the processor 160 may identify the initial positions of the elements 21, 22, 23.

Alternatively, when there is no specific marking on the elements 21, 22, 23, the processor 160 arbitrarily specifies any one 21 among the elements 21, 22, 23. Then, the processor 160 may check positional relationships between the specified element 21 and the other elements 22, 23 through the camera 120. Accordingly, the processor 160 may identify the initial positions of the elements 21, 22, 23.

After the initial positions of the elements 21, 22, 23 are identified, the processor 160 obtains movement information of the elements 21, 22, 23.

As an example, the processor 160 senses a movement of the elements 21, 22, 23 through the LiDAR sensor of the aerial vehicle 10. Also, the processor 160 may generate the movement information of the elements 21, 22, 23 by using the initial positions of the elements 21, 22, 23 and the sensed movement.

Specifically, the processor 160 may activate the LiDAR sensor to transmit a signal toward the object 20. When the aerial vehicle 10 transmits the signal in the same direction from the same position, the elements 21, 22, 23 may be sensed intermittently as they rotate. For example, sensing may be performed in an order of the first element 21->the second element 22->the third element 23->the first element 21->and so on.

Since the initial positions of the elements 21, 22, 23 at the reference time point have been confirmed, the processor 160 may generate the movement information of the elements 21, 22, 23 in consideration of a time interval at which the elements 21, 22, 23 are intermittently sensed.

As another example, the processor 160 may generate the movement information of the elements 21, 22, 23 by using the initial positions of the elements 21, 22, 23 and a preset speed v. Here, the preset speed v means a speed at which the elements 21, 22, 23 rotate.

Specifically, since the initial positions of the elements 21, 22, 23 at the reference time point have been confirmed, the processor 160 may generate the movement information of the elements 21, 22, 23 in consideration of the preset speed v.

If a wind is blowing around the object 20, the processor 160 may sense a wind speed and a wind direction around the object 20. The processor 160 may generate the movement information of the elements 21, 22, 23 by taking into account the wind speed and the wind direction around the object 20 with respect to the preset speed v.

Referring back to FIG. 4, in step 420, the processor 160 generates first images in which at least a portion of at least one element is captured through at least one camera 120 of the aerial vehicle 10.

For example, the processor 160 may set a movement path of the aerial vehicle 10 in consideration of an estimated cost according to the capturing. Also, the processor 160 may generate the first images as the element is captured at each of a plurality of capturing positions set according to the movement path.

As an example, when the aerial vehicle 10 includes a single camera, the processor 160 may control the camera to perform capturing while adjusting a capturing angle of the camera at each of the capturing positions. As another example, when the aerial vehicle 10 includes a plurality of cameras set with different capturing angles, the processor 160 may control the cameras to simultaneously capture at each of the capturing positions.

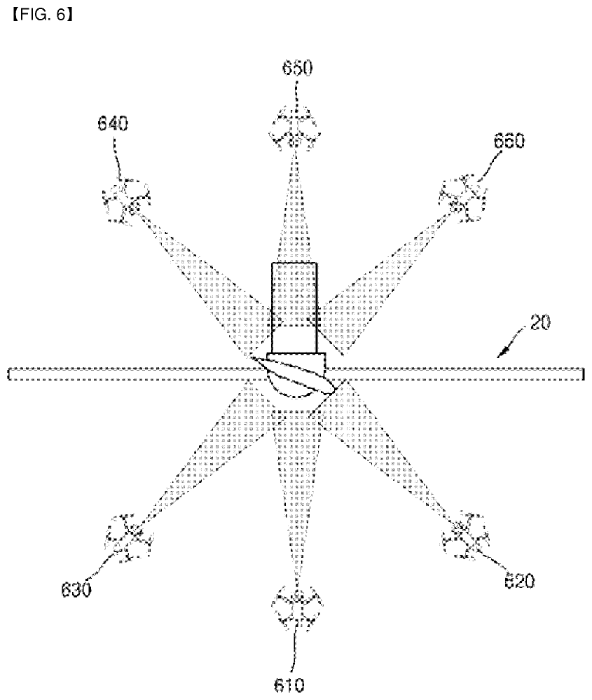

Hereinafter, examples in which the processor 160 generates the first images will be described with reference to FIGS. 6 to 9.

FIG. 6 is a diagram for describing an example in which a processor sets a movement path of an aerial vehicle according to an embodiment.

In FIG. 6, the object 20 and capturing directions in which the aerial vehicle 10 captures the object 20 from a viewpoint looking down at the object 20 from above are illustrated.

Meanwhile, although a total of six capturing directions 610 to 660 are illustrated as positions of the aerial vehicle 10 in FIG. 6, the number of capturing directions in which the aerial vehicle 10 captures the object 20 is not limited thereto. In other words, as long as the aerial vehicle 10 can capture all sides of the object 20 or the elements without omission, the number of capturing directions may be greater or fewer than the number illustrated in FIG. 6.

The processor 160 sets a movement path of the aerial vehicle 10 in consideration of an estimated cost according to the capturing. That the processor 160 sets the movement path may mean determining the capturing directions and capturing positions, and determining an order of the capturing directions and the capturing positions. The processor 160 may first determine the order of the capturing directions, and may determine the capturing positions at each of the capturing directions. The processor 160 may determine a plurality of capturing positions in any one capturing direction, and the aerial vehicle 10 captures the object 20 at each of the plurality of capturing positions.

The processor 160 may determine the capturing directions to capture all sides of the object 20, and may determine the capturing positions in each of the capturing directions to capture the elements without omission. Here, the estimated cost is a concept including a time required to capture all sides of the moving object 20 or the moving elements without omission, and power (or fuel) consumed by the aerial vehicle 10. For example, the processor 160 may set the movement path of the aerial vehicle 10 such that the estimated cost is minimized. Alternatively, the processor 160 may set the movement path such that a possibility of collision between the blades and the aerial vehicle 10 is minimized.

The processor 160 may determine the capturing directions based on a plane of rotation of the object 20. For example, the processor 160 sets capturing directions 610, 620, 630 on one side surface of the object 20, and after capturing is completed in the capturing directions 610, 620, 630, may set the movement path to move to another side surface of the object 20. For example, the aerial vehicle 10 starts capturing at the capturing direction 610 for the object 20, captures the object 20 at the capturing direction 620 after the capturing is completed, captures the object 20 at the capturing direction 630 after the capturing is completed, captures the object 20 at the capturing direction 640 after the capturing is completed, captures the object 20 at the capturing direction 650 after the capturing is completed, and captures the object 20 at the capturing direction 660 after the capturing is completed to set the movement path. That the aerial vehicle 10 captures the object 20 in any one capturing direction may mean that the aerial vehicle 10 captures the object 20 at a plurality of capturing positions while maintaining the capturing direction.

According to FIG. 6, the processor 160 may set the capturing directions 610 to 660 to all have the same angle difference. For example, assuming that the capturing direction 610 is 0°, the processor 160 may set the capturing direction 650 to 180°, and the capturing directions 620, 630 to +45°, and the capturing directions 640, 660 to +135°. If assuming that there are a total of four capturing directions, the processor 160 may set the capturing directions to +45°, +135°. In other words, assuming that there are a total of four capturing directions, the processor 160 may set four capturing directions 620, 630, 640, 660.

As an example, when the processor 160 knows position information (e.g., GPS coordinates) of the object 20, the processor 160 may set a virtual line connecting the aerial vehicle 10 and the object 20 at a point where capturing starts. Also, the processor 160 may set the corresponding line as 0°, and may set the capturing directions 610 to 660 by calculating surrounding angles.

As another example, the processor 160 may sense the object 20 at a point where capturing starts using the LiDAR sensor, and may set the sensed point as a reference position. Also, the processor 160 may set the reference position as 0°, and may set the capturing directions 610 to 660 by calculating surrounding angles.

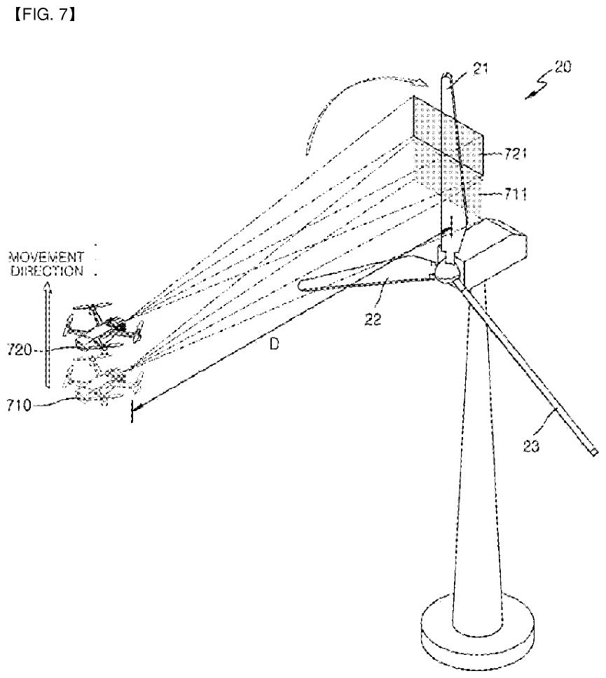

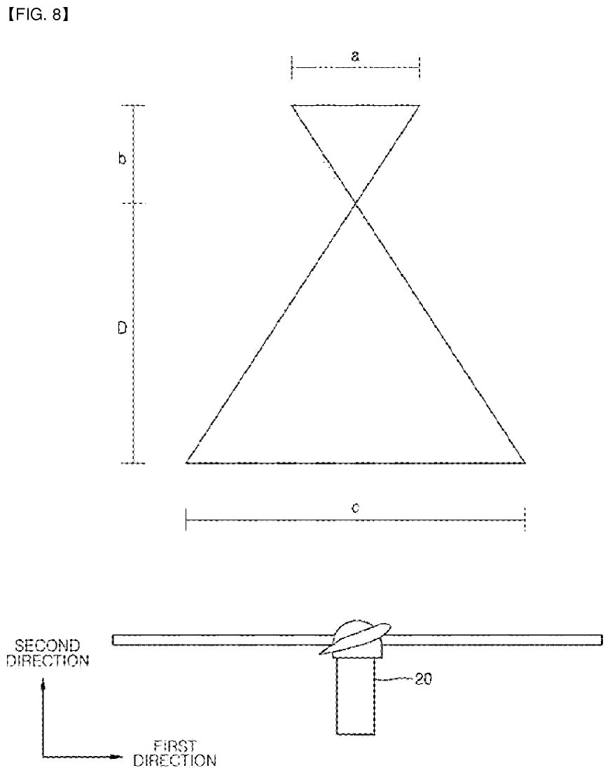

Meanwhile, the processor 160 may control the aerial vehicle 10 so as to capture the object 20 or the elements while moving. Hereinafter, an example in which the aerial vehicle 10 captures the object 20 or the elements while moving up and down will be described with reference to FIGS. 7 and 8. However, an example in which the aerial vehicle 10 captures the object 20 or the elements while moving side to side or diagonally is also possible.

FIG. 7 is a diagram for describing an example in which a processor captures while moving an aerial vehicle up and down according to an embodiment. In FIG. 7, the aerial vehicle 10 may capture the object 20 while maintaining a capturing direction and changing capturing positions. The movement direction of the aerial vehicle 10 may be perpendicular to the capturing direction, but may vary depending on an angle of the camera 120, a posture of the aerial vehicle 10, and the like.

In FIG. 7, the object 20 and capturing positions 710, 720 of the aerial vehicle 10 from a viewpoint looking at the object 20 from the side are illustrated. The aerial vehicle 10 may capture the object 20 at the capturing positions 710, 720 while maintaining a capturing direction. Although only two capturing positions 710, 720 are illustrated in FIG. 7, the aerial vehicle 10 may capture the object 20 at more capturing positions.

Referring to FIG. 7, the aerial vehicle 10 captures the object 20 at the capturing position 710, and moves to the capturing position 720 to capture the object 20. In this manner, the aerial vehicle 10 may capture the object 20 or the elements 21, 22, 23 while moving up and down. For example, when the object 20 is a wind power generator, the aerial vehicle 10 may capture the wind power generator or the blades while moving from a root of a blade to a direction of a tip or from the tip to a direction of the root at a plurality of capturing positions.

Meanwhile, the number of capturing positions may be variously set so that the front sides of the object 20 or the elements 21, 22, 23 are captured without omission. In other words, the processor 160 may set the number of capturing positions so that the front sides of the elements 21, 22, 23 at the capturing positions 710, 720 are captured without omission. In FIG. 7, for convenience of description, areas 711, 721 are illustrated as being separated, but the areas 711, 721 may be overlapped, and although only two capturing positions 710, 720 are illustrated, the aerial vehicle 10 may capture the elements 21, 22, 23 at more capturing positions.

At this time, the processor 160 may control the aerial vehicle 10 by making it move up and down while maintaining the same distance D between the aerial vehicle 10 and the object 20. Determining the distance D between the aerial vehicle 10 and the object 20 by the processor 160 will be described with reference to FIG. 8.

FIG. 8 is a diagram for describing an example in which a processor determines a distance between an aerial vehicle and an object according to an embodiment.

Referring to FIG. 8, the processor 160 may determine a distance D between the aerial vehicle 10 and the object 20 based on a focal length b of a lens included in the camera 120, a length a in a first direction of an image sensor included in the camera 120, and a length c in the first direction of an area captured through the camera 120. In FIG. 8, b and D are illustrated for ease of understanding, but b may be a very small distance compared to D.

For example, the processor 160 may calculate the distance D between the aerial vehicle 10 and the object 20 by Equation 1 below.

$$D = \frac{b \times C}{a} \qquad [ Equation 1 ]$$

For example, it is assumed that the focal length b of the lens is 75 mm, the length a in the first direction of the image sensor is 11.27 mm, the length c in the first direction of the captured area is 5 m, and the capturing position of the aerial vehicle 10 is the capturing direction 610, 650 of FIG. 6. In this case, the processor 160 may set the distance D between the aerial vehicle 10 and the object 20 to 33.27 m. By maintaining the distance with the object 20, the aerial vehicle 10 may receive less influence of wind caused by the rotation of the object 20.

Meanwhile, when the aerial vehicle 10 captures the object 20 diagonally (e.g., from the capturing directions 620, 630, 640, 660 of FIG. 6), the processor 160 may set the distance D between the aerial vehicle 10 and the object 20 as a distance obtained by dividing a distance from the front (e.g., a distance between the aerial vehicle 10 and the object 20 in the capturing directions 610, 650) by sqrt(2). In the case of the above-described example, the processor 160 may set the distance D between the aerial vehicle 10 and the object 20 to about 23 m (=33.27 m/sqrt(2)).

Referring back to FIG. 7, the aerial vehicle 10 moves to another position to perform capturing after capturing all of the elements 21, 22, 23 at the capturing position 710. In other words, after capturing all of the elements included in the object 20 at the same position, the aerial vehicle 10 moves to another position and performs capturing. The aerial vehicle 10 captures identical parts of the three elements 21, 22, 23 at the capturing position 710, and moves to the capturing position 720.

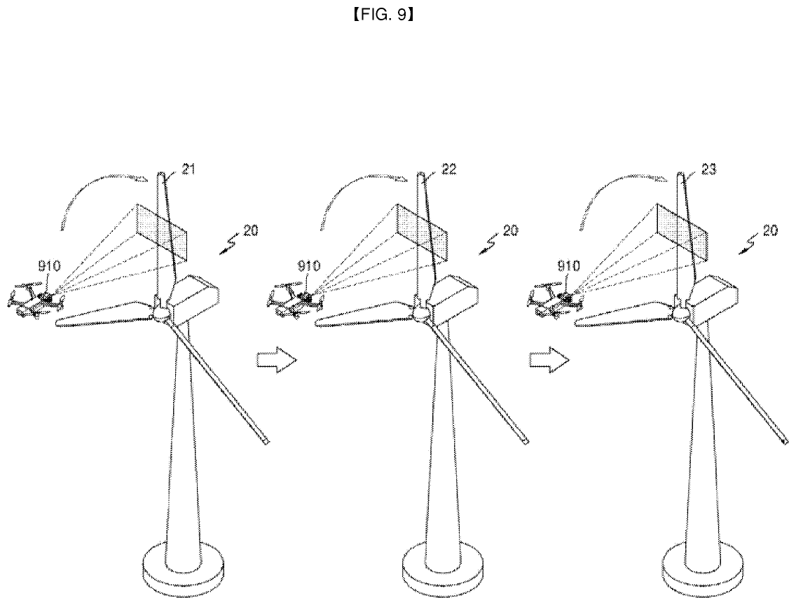

Meanwhile, depending on the type and/or number of cameras 120 included in the aerial vehicle 10, the aerial vehicle 10 may perform capturing one or more times at the same position. An example in which the aerial vehicle 10 performs capturing at the same position will be described with reference to FIG. 9.

FIG. 9 is a diagram for describing an example in which an aerial vehicle performs capturing at the same position according to an embodiment.

Referring to FIG. 9, the aerial vehicle 10 may capture all of the elements 21, 22, 23 at a capturing position 910. Specifically, when the elements 21, 22, 23 are rotating, the aerial vehicle 10 may capture the elements 21, 22, 23 while staying at the capturing position 910. As described above with reference to FIG. 7, when capturing at the capturing position 910 is completed, the aerial vehicle 10 may move to another capturing position and capture the elements 21, 22, 23.

When each of the elements 21, 22, 23 is captured at the capturing position 910, the number of times of capturing may vary depending on the type and/or number of cameras 120. In other words, the processor 160 may control the camera 120 such that capturing is performed one or more times for each of the elements 21, 22, 23 at the capturing position 910.

When the aerial vehicle 10 includes a single camera, the processor 160 may control the camera to perform capturing while adjusting a capturing angle of the camera at the capturing position 910. For example, the processor 160 may capture each of the elements 21, 22, 23 multiple times while changing the capturing angle of the camera up and down or left and right. For example, the processor 160 may set the capturing angle of the camera to −15 degrees and capture the elements 21, 22, 23, set the capturing angle of the camera to 0 degrees and capture the elements 21, 22, 23, and set the capturing angle of the camera to +15 degrees and capture the elements 21, 22, 23. By capturing while adjusting the capturing angle of the camera by the aerial vehicle 10, the number of capturing positions of the aerial vehicle 10 may be reduced. In addition, since capturing is performed while changing only the capturing angle of the camera in a state where the capturing position of the aerial vehicle 10 is fixed, it is easy to generate the second image by combining the first images.

When the aerial vehicle 10 includes a plurality of cameras, the processor 160 may control the cameras to simultaneously perform capturing at the capturing position 910. For example, the plurality of cameras may be arranged in a vertical direction or a horizontal direction such that different areas are captured. Accordingly, the same effect as a single camera capturing each of the elements 21, 22, 23 multiple times while changing a capturing angle up and down or left and right can be implemented.

Meanwhile, the processor 160 may control the camera 120 such that each of the elements 21, 22, 23 is captured twice or more at the capturing position 910. For example, in order to secure a sufficient amount of light, the processor 160 may consecutively capture each of the elements 21, 22, 23 at the capturing position 910.

Since capturing proceeds while the elements 21, 22, 23 are moving, a single capturing alone may not secure a sufficient amount of light capable of ensuring image quality of a certain level or higher. Accordingly, as each of the elements 21, 22, 23 is continuously captured at the capturing position 910, high-quality images can be generated.

Meanwhile, the processor 160 may calculate an exposure time of the camera 120 according to a rotation speed of the elements 21, 22, 23, a resolution of the camera 120, and an actual distance represented in a width on a single image. Here, the actual distance represented in the width on the single image means an actual distance of an element corresponding to a portion of the element represented in the image.

For example, when the element is a blade of a wind power generator, a Tip Speed Ratio (TSR) (λ), which is a ratio of a linear velocity (Vₜᵢₚ) of the blade to a speed (V_{wind}) of wind blowing around the blade, may be calculated as in Equation 2 below.

$$λ = \frac{{V}_{tip}}{{V}_{wind}} \qquad [ Equation 2 ]$$

If it is assumed that the actual distance of the blade captured in an image width is 5 m, and specifications of the camera 120 are 5000*4000 pixels. And, it is assumed that a tip of the blade passes 0.2 pixels of the image while the camera 120 performs capturing (that is, a blur coefficient (C_{blur}) is 0.2). In addition, it is assumed that the TSR (λ) is 6 and the wind speed (V_{wind}) is 15 m/s.

In this case, a length of a pixel (Lₚᵢₓₑₗ) is 1 mm (that is, 1/1000m), and the linear velocity of the blade (Vₜᵢₚ) is 90 m/s, so the processor 160 may calculate an exposure time (tₑₓₚₒₛᵤᵣₑ) of the camera 120 to be 2.222 us according to Equation 3 below.

$${t}_{exposure} = {C}_{blur} * \frac{{L}_{pixel}}{{V}_{tip}} \qquad [ Equation 3 ]$$

That is, when the blade is captured with a camera having an exposure time (tₑₓₚₒₛᵤᵣₑ) of about 2 μs, only a blur of about 0.2 pixels may occur in an image.

Referring back to FIG. 4, in step 430, the processor 160 generates the second image corresponding to at least one element by using the first images and the movement information.

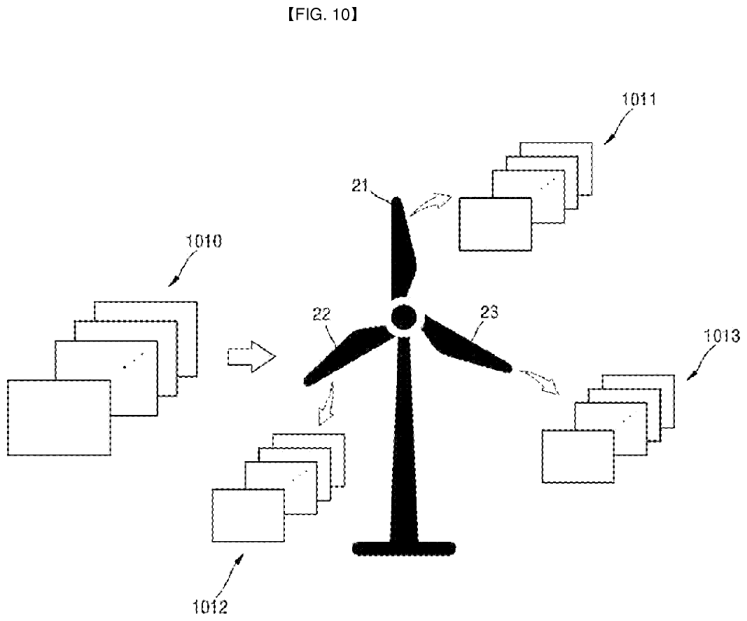

For example, the processor 160 may classify the first images for each element by using the movement information. Also, the processor 160 may generate the second image by combining the images classified for each element. Hereinafter, an example in which the processor 160 generates the second image will be described with reference to FIG. 10.

FIG. 10 is a diagram for describing an example in which a processor generates a second image according to an embodiment.

Referring to FIG. 10, the processor 160 may classify first images 1010 for the respective elements 21, 22, 23. In other words, the processor 160 may distinguish which element is captured in each of the first images 1010 among the elements 21, 22, 23.

As described above with reference to step 410, the processor 160 may obtain movement information of the elements 21, 22, 23. In other words, the processor 160 may identify where the elements 21, 22, 23 are located at a specific time point. In addition, the processor 160 may also check information on time points when the first images 1010 were captured and information on capturing positions corresponding to the first images 1010. Therefore, the processor 160 may determine which element among the elements 21, 22, 23 each of the first images 1010 corresponds to.

Accordingly, the processor 160 may group the first images 1010 to generate groups 1011, 1012, 1013 respectively corresponding to the elements 21, 22, 23. Thereafter, the processor 160 may generate the second image by combining images included in each of the groups 1011, 1012, 1013. The second image may be an image representing the entirety of one side of an element. In other words, the second image may be generated by combining the first images generated by capturing a single element in a single capturing direction.

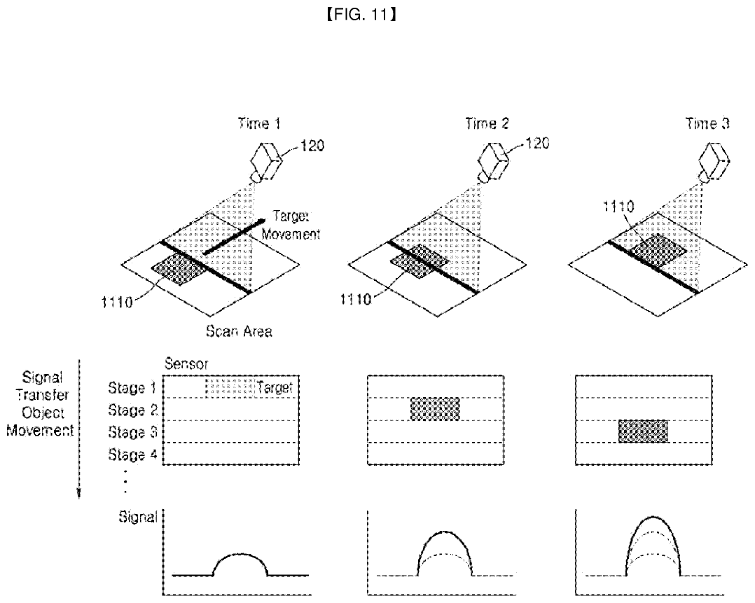

If the camera 120 is a Time Delay and Integration (TDI) camera, an example in which the processor 160 generates the second image will be described with reference to FIG. 11.

FIG. 11 is a diagram for describing an example in which a processor generates first images when a camera is a TDI camera according to an embodiment.

Referring to FIG. 11, when an element 1110 enters a field of view of the camera 120 while rotating (time 1), the processor 160 controls the camera 120 so that capturing is started. In addition, when the element 1110 deviates from the field of view of the camera 120 while rotating (time 3), the processor 160 controls the camera 120 so that capturing is finished. While the element 1110 is included in the field of view of the camera 120 (time 1 to time 3), the processor 160 generates images by capturing the element 1110 multiple times through the camera 120. The processor 160 then generates first images by superimposing the images.

For example, an image sensor of the camera 120 may be composed of multiple stages, and the processor 160 may generate images by using the stages. When the element 1110 moves and is located from a capturing area of a first stage to a capturing area of a last stage, the processor 160 accumulates signals output from each stage. Also, the processor 160 may generate an image accumulated as much as the number of stages. Thus, the processor 160 captures identical parts of the element 1110 four times (stage 1 to stage 4) to secure a light amount and to generate an image with less blur.

FIG. 12 is a configuration diagram for describing an example of an apparatus for capturing a moving object according to an embodiment.

Referring to FIG. 12, an apparatus 1200 for capturing a moving object includes a processor 1210, a memory 1220, and a communication device 1230. However, components of the apparatus 1200 are not limited to those illustrated in FIG. 12. In other words, the apparatus 1200 may further include at least one component in addition to the components illustrated in FIG. 12, or at least one of the components illustrated in FIG. 12 may be omitted.

As described above with reference to FIG. 3, the apparatus 1200 may be included in at least one of the aerial vehicle 10, the server 30, the controller 40, the station 50, and other external devices. Accordingly, the processor 160, the memory 130, and the communication device 150 described above with reference to FIG. 3 may correspond to the processor 1210, the memory 1220, and the communication device 1230 of the apparatus 1200, respectively. Therefore, a detailed description of the processor 1210, the memory 1220, and the communication device 1230 will be omitted.

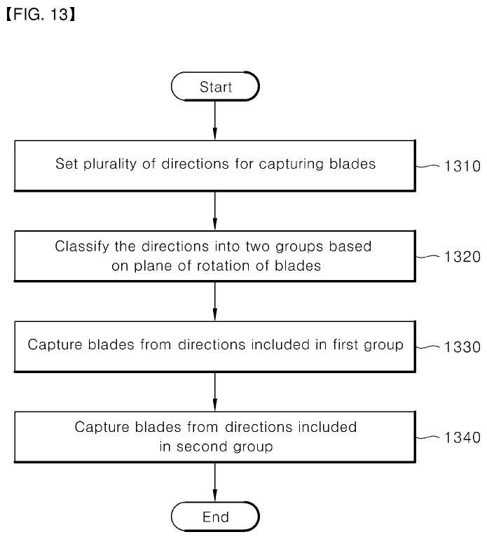

FIG. 13 is a flowchart for describing a method of capturing a wind power generator according to an embodiment.

In step 1310, the aerial vehicle 10 sets a plurality of directions for capturing blades. The aerial vehicle 10 captures the blades from the plurality of directions. For example, the aerial vehicle 10 may capture the blades from 4 or 6 directions. The aerial vehicle 10 may set the directions to capture all sides of the blades.

In step 1320, the aerial vehicle 10 classifies the directions into two groups based on a plane of rotation of the blades. The plane of rotation may include a space through which the blades pass while rotating. For example, the plane of rotation may be a plane perpendicular to a line of sight of the aerial vehicle 10 when the aerial vehicle 10 looks at a nose of the wind power generator from the front. For example, the aerial vehicle 10 may classify capturing directions from a front side of the plane of rotation into a first group, and capturing directions from a rear side of the plane of rotation into a second group.

In step 1330, the aerial vehicle 10 captures the blades from the directions included in the first group. For example, if three directions are included in the first group, the aerial vehicle 10 may capture the blades from the three directions. When capturing the blades in any one direction, the aerial vehicle 10 may capture the blades at a plurality of capturing positions.

After capturing the blades from the directions included in the first group, the aerial vehicle 10 may move past the plane of rotation. Because the blades are rotating, it is necessary to minimize the number of times the aerial vehicle 10 passes through the plane of rotation. Since the first group and the second group are classified based on the plane of rotation, while capturing is performed in any one group, the aerial vehicle 10 does not pass through the plane of rotation. Therefore, a risk of the aerial vehicle 10 colliding with the rotating blades may be reduced.

In step 1340, the aerial vehicle 10 captures the blades from the directions included in the second group. Describing a method of capturing the blades in any one direction, the aerial vehicle 10 captures the blades while hopping in a direction moving away from or closer to the nose. Capturing while hopping means that the aerial vehicle 10 captures the blades while hovering at one position, and then moves to another position and captures the blades while hovering.

The aerial vehicle 10 captures identical parts of the blades at any one position. For example, the aerial vehicle 10 captures a first portion of the blades while hovering at a first position, and moves to a second position to capture a second portion of the blades while hovering. The aerial vehicle 10 may capture a tip of a first blade, capture a tip of a second blade, and capture a tip of a third blade at the first position. Conventionally, because a blade is captured in a state where the blade is stopped, the aerial vehicle 10 cannot capture two or more blades at one position, but if a blade is captured while the blade is rotating, the aerial vehicle 10 can capture two or more blades at one position.

The aerial vehicle 10 may change a movement direction every time a capturing direction is changed. The capturing direction is an angle at which the aerial vehicle 10 looks at the blade, and the movement direction is a direction in which the aerial vehicle 10 changes its position while maintaining the capturing direction. For example, the aerial vehicle 10 may move from the nose to a tip direction when capturing the blade in a first capturing direction, move from the tip to the nose direction when capturing the blade in a second capturing direction, and move from the nose to the tip direction when capturing the blade in a third capturing direction. Therefore, when capturing in N capturing directions, the aerial vehicle 10 may change the movement direction N−1 times.

According to the above description, the processors 160 and 1210 may generate high-quality images of the object 20 by using images captured while the object 20 is moving.

Meanwhile, the above-described method can be written as a program executable on a computer, and can be implemented in a general-purpose digital computer that operates the program by using a computer-readable recording medium. In addition, the structure of the data used in the above-described method can be recorded on a computer-readable recording medium through various means. The computer-readable recording medium includes a storage medium such as a magnetic storage medium (e.g., ROM, RAM, USB, floppy disk, hard disk, etc.) and an optical reading medium (e.g., CD-ROM, DVD, etc.).

Those of ordinary skill in the art related to the present embodiment will be able to understand that it can be implemented in a modified form without departing from the essential characteristics of the above description. Therefore, the disclosed methods should be considered from a descriptive point of view rather than a limiting point of view, and the scope of rights is shown in the claims rather than the foregoing description, and all differences within the equivalent scope should be construed as being included.

### DESCRIPTION OF SYMBOLS

10: Aerial vehicle
20: Object

1. A method of capturing a moving object comprising:
obtaining movement information of at least one element included in an object;
generating first images in which at least a portion of the at least one element is captured by controlling at least one camera of an aerial vehicle; and
generating a second image corresponding to the at least one element by using the first images and the movement information,
wherein the generating the second image comprises:
classifying the first images for each element by using the movement information and information on a capturing time at which each of the first images is captured; and
generating the second image by combining the images classified for each element.

2. The method of claim 1, wherein the obtaining step comprises:
identifying an initial position of the at least one element at a reference time point before capturing is performed;
sensing a movement of the at least one element through a LiDAR sensor of the aerial vehicle; and
obtaining the movement information by using the initial position and the sensed movement.

3. The method of claim 1, wherein the obtaining step comprises:
identifying an initial position of the at least one element at a reference time point before capturing is performed; and
obtaining the movement information by using the initial position and a preset speed.

4. The method of claim 1, wherein the generating of the first images comprises:
setting a movement path of the aerial vehicle in consideration of an estimated cost according to the capturing; and
generating the first images as the at least one element is captured at each of a plurality of capturing positions set according to the movement path.

5. The method of claim 4, wherein the movement path is set such that a plurality of capturing positions are set on one side surface of the object, and after capturing at the capturing positions is completed, the aerial vehicle moves to another side surface of the object.

6. The method of claim 1, wherein the generating of the first images comprises:
determining a distance between the aerial vehicle and the object based on a focal length of a lens included in the camera, a length in a first direction of an image sensor included in the camera, and a length in the first direction of an area captured through the camera; and
generating the first images by capturing the object at the determined distance.

7. The method of claim 1, wherein the generating of the first images comprises:
when the aerial vehicle includes a single camera, generating the first images by capturing while adjusting a capturing angle of the single camera at each of capturing positions.

8. The method of claim 1, wherein the generating of the first images comprises:
when the aerial vehicle includes a plurality of cameras set with different capturing angles, generating the first images as the plurality of cameras simultaneously capture at each of capturing positions.

9. A computer-readable recording medium recording a program for executing the method of claim 1 on a computer.

10. An apparatus for capturing a moving object, comprising:
at least one memory; and
at least one processor,
wherein the at least one processor is configured to obtain movement information of at least one element included in an object, generate first images in which at least a portion of the at least one element is captured through at least one camera of an aerial vehicle, and generate a second image corresponding to the at least one element by using the first images and the movement information,
wherein, to generate the second image, the at least one processor is configured to classify the first images for each element by using the movement information and information on a capturing time at which each of the first images is captured, and generate the second image by combining the images classified for each element.

11. The apparatus of claim 10, wherein the at least one processor is configured to identify an initial position of the at least one element at a reference time point before capturing is performed, sense a movement of the at least one element through a LIDAR sensor of the aerial vehicle, and obtain the movement information by using the initial position and the sensed movement.

12. The apparatus of claim 10, wherein the at least one processor is configured to identify an initial position of the at least one element at a reference time point before capturing is performed, and obtain the movement information by using the initial position and a preset speed.

13. The apparatus of claim 10, wherein the at least one processor is configured to set a movement path of the aerial vehicle in consideration of an estimated cost according to the capturing, and generate the first images as the at least one element is captured at each of a plurality of capturing positions set according to the movement path.

14. The apparatus of claim 13, wherein the movement path is set such that a plurality of capturing positions are set on one side surface of the object, and after capturing at the capturing positions is completed, the aerial vehicle moves to another side surface of the object.

15. The apparatus of claim 10, wherein the at least one processor is configured to determine a distance between the aerial vehicle and the object based on a focal length of a lens included in the camera, a length in a first direction of an image sensor included in the camera, and a length in the first direction of an area captured through the camera, and generate the first images by capturing the object at the determined distance.

16. The apparatus of claim 10, wherein the at least one processor is configured to, when the aerial vehicle includes a single camera, control the single camera to capture while adjusting a capturing angle of the single camera at each of capturing positions.

17. The apparatus of claim 10, wherein the at least one processor is configured to, when the aerial vehicle includes a plurality of cameras set with different capturing angles, control the plurality of cameras to simultaneously capture at each of capturing positions.

18. An aerial vehicle comprising:
at least one camera;
at least one memory; and
at least one processor,
wherein the at least one processor is configured to obtain movement information of at least one element included in an object, generate first images in which at least a portion of the at least one element is captured through the at least one camera, and generate a second image corresponding to the at least one element by using the first images and the movement information,
wherein, when generating the second image, the at least one processor is configured to classify the first images for each element by using the movement information and information on a capturing time at which each of the first images is captured, and generate the second image by combining the images classified for each element.
